(19) United States
(12) Patent Application Publication
(10) Pub. No.: US 2025/0117621 A1
(43) Pub. Date: Apr. 10, 2025

(54) RFID MODULE

(71) Applicant: Murata Manufacturing Co., Ltd., Nagaokakyo-shi (JP)

(72) Inventor: Noriyuki UEKI, Nagaokakyo-shi (JP)

(21) Appl. No.: 18/985,394

(22) Filed: Dec. 18, 2024

Related U.S. Application Data
(63) Continuation of application No. PCT/JP2023/037062, filed on Oct. 12, 2023.

(30) Foreign Application Priority Data
Oct. 14, 2022 (JP) 2022-165734

(51) Int. Cl. G06K 19/077; H01F 27/28; H01F 27/29

(52) U.S. Cl. CPC G06K 19/07749; H01F 27/2823; H01F 27/29

(57) ABSTRACT

An RFID module is provided that includes a substrate having a first main surface and a second main surface, an RFIC chip disposed on the first main surface of the substrate, and a coil element having a conductive wire having a plurality of windings. A first end of the RFIC chip is electrically connected to a first end of the coil element. A second end of the RFIC chip is electrically connected to a second end of the coil element. The coil element has at least one sparsely wound portion, and both ends of the coil element are first densely wound portions in which the conductive wire is wound at a narrower pitch than the pitch in the sparsely wound portion.

### CROSS REFERENCE TO RELATED APPLICATIONS

The present application is a continuation of International Application No. PCT/JP2023/037062, filed Oct. 12, 2023, which claims priority to Japanese Patent Application No. 2022-165734, filed Oct. 14, 2022, the entire contents of each of which are hereby incorporated by reference in their entirety.

### TECHNICAL FIELD

The present invention relates to an RFID module having a substrate on which a coil conductor is mounted.

### BACKGROUND

Conventionally, a product has been managed by attaching a radio-frequency identification (RFID) module, which is a wireless communication device, to the product. One form of the RFID module is one in which a coil conductor functioning as an antenna is disposed on an insulating substrate together with a radio-frequency integrated circuit (RFIC) chip.

For example, WO 2018/235714 describes an RFID module that includes a coil conductor in which coil elements with legs for mounting are arranged in a line.

The coil conductor in the RFID module described in WO 2018/235714 has legs for mounting, so that the coil opening diameter is reduced by the amount of mounting space. In order to ensure antenna characteristics, the RFID module becomes larger.

### SUMMARY OF THE INVENTION

Therefore, it is an object of the present disclosure to provide an RFID module that is reduced in size while keeping antenna characteristics.

In an exemplary aspect, an RFID module is provided that includes a substrate having a first main surface and a second main surface; an RFIC chip on the first main surface of the substrate; and a coil element having a conductor wound a plurality of times. A first end of the RFIC chip is electrically connected to a first end of the coil element, while a second end of the RFIC chip is electrically connected to a second end of the coil element. The coil element has at least one sparsely wound portion, with both ends of the coil element being first densely wound portions in which the conductor is wound with a narrower pitch than a pitch in the sparsely wound portion.

According to the exemplary aspects of the present disclosure, an RFID module is provided that is reduced in size while maintaining the antenna characteristics.

### BRIEF DESCRIPTION OF DRAWINGS

FIG. 1 is a longitudinal sectional view showing a schema of an RFID module according to a first exemplary embodiment.

FIG. 2 is a perspective view of a coil element.

FIG. 3 is a cross-sectional view of a conductor of the coil element.

FIG. 4A-4B are plan views showing wiring electrodes on a substrate of the first exemplary embodiment.

FIG. 5 is a plan view illustrating current flowing through a metal plate when the RFID module is placed on the metal plate.

FIG. 6 is a longitudinal sectional view illustrating current flowing through the metal plate when the RFID module is placed on the metal plate.

FIG. 7 is a longitudinal sectional view showing a schema of an RFID module according to a second exemplary embodiment.

FIG. 8A-8D are plan views showing each base material layer of the laminated substrate.

FIG. 9 is a longitudinal sectional view showing a schema of an RFID module according to a variant.

### DETAILED DESCRIPTION OF EMBODIMENTS

Exemplary embodiments described below each illustrate an example of the present disclosure, but it should be appreciated that the present disclosure is not limited to these configurations. Furthermore, the numerical values, shapes, configurations, steps, and order of steps specifically shown in the following embodiments show examples and should not be so limited. Furthermore, in all of the exemplary embodiments, configurations in their respective variants are also similar, and the configuration described in each variant may be combined with each other.

### First Exemplary Embodiment

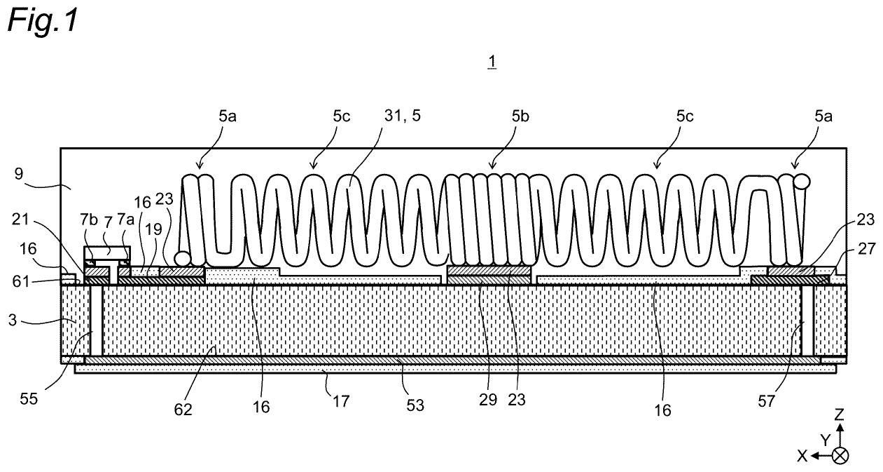

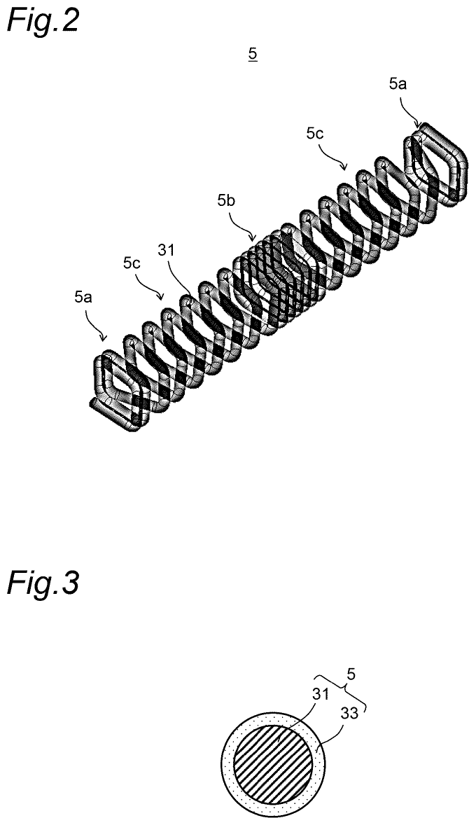

A schematic configuration of an RFID module 1 according to a first exemplary embodiment will now be described. FIG. 1 is a longitudinal sectional view of the RFID module 1 of the first exemplary embodiment. FIG. 2 is a perspective view of a coil element. In the figures, the X-Y-Z coordinate system is used to facilitate understanding of the exemplary embodiment of the present disclosure and should not be so limited. The X-axis direction indicates the longitudinal direction of the RFID module 1, the Y-axis direction indicates the depth (width) direction, and the Z-axis direction indicates the thickness direction. The X, Y, and Z directions are mutually orthogonal according to the exemplary aspects. Moreover, in the embodiment, the positive direction of the Z axis is described as the upward direction, while the negative direction of the Z axis is described as the downward direction.

As shown, the RFID module 1 includes a substrate 3; a coil element 5 and an RFIC chip 7 that are arranged on a first main surface 61 that is the upper surface of the substrate 3; and a resin layer 9 that seals the coil element 5 and the RFIC chip 7. The RFIC chip 7 has a first terminal 7a and a second terminal 7b that are configured as input/output terminals. The substrate 3 in the first embodiment is a double-sided substrate, with a second main surface 62 that is the lower surface of the substrate 3 and the first main surface 61 facing each other. The substrate 3 has insulation properties and is, for example, a glass epoxy substrate or a ceramic substrate.

As further shown, a first resist layer 16 is laminated on the first main surface 61 of the substrate 3, and a second resist layer 17 is laminated on the second main surface 62 of the substrate 3. The first resist layer 16 prevents short-circuiting of electrodes and wiring arranged on a first base material layer 11, and the second resist layer 17 covers and protects the lower ends of a first interlayer connection conductor 55 and a second interlayer connection conductor 57, which will be described later. The first resist layer 16 and the second resist layer are, for example, insulating resin layers in an exemplary aspect.

As shown in FIGS. 1 and 2, the coil element 5 is configured by winding a conductive wire 31 plural times (e.g., a plurality of windings), and thus the coil element 5 is configured to function as an antenna. In an exemplary aspect, the communication frequency band in the RFID module 1 of the embodiment is, for example, a UHF band from 860 MHz to 960 MHz. It should be appreciated that the number of turns and dimensions of the coil element 5 may be changed depending on the communication characteristics.

The coil element 5 has a first densely wound portion 5a, a second densely wound portion 5b, and a sparsely wound portion 5c. The coil element 5 is an air-core coil that does not have a cavity or a magnetic core material along the winding axis (e.g., inside coil element 5). The first densely wound portion 5a is formed at both ends of the coil element 5, and the second densely wound portion 5b is formed between the first densely wound portions 5a at both ends, for example, in the center of the coil element 5. The sparsely wound portion 5c is formed between the first densely wound portion 5a and the second densely wound portion 5b. According to the exemplary aspect, the term “densely wound” means that the winding pitch of the conductive wire 31 is narrower (i.e., smaller pitch with windings closer together) in the first densely wound portion 5a and the second densely wound portion 5b than in the sparsely wound portion 5c, and, for example, the wire diameter and the winding pitch of the conductive wire 31 may be the same. In this case, the conductive wire 31 is in contact with each other in the first densely wound portion 5a and the second densely wound portion 5b.

According to an exemplary aspects, the total number of turns of the sparsely wound portion 5c is equal to or greater than the total number of turns of the first densely wound portion 5a and the second densely wound portion 5b, and is, for example, equal to or greater than twice the number of turns. In the first densely wound portion 5a, the number of turns of the conductive wire 31 is, for example, equal to or greater than two.

The respective first densely wound portions 5a are connected via a solder 23 to a first land 19 and a first electrode 27, respectively, arranged on the first main surface of the substrate 3. In this manner, the first densely wound portions 5a is configured to function as solder joint portions. The second densely wound portion 5b is configured to function as a portion to be sucked when the substrate is sucked by a component mounter, and may be connected via the solder 23 to an auxiliary electrode 29 arranged on the first main surface of the substrate 3. This configuration prevents the coil element 5 from bending when the resin layer 9 is molded. The length of the second densely wound portion 5b in the X-axis direction is greater than the hole diameter of the suction nozzle of the component mounter.

Reference is now made to FIG. 3. FIG. 3 is a cross-sectional view of the conductive wire 31 of the coil element 5. The conductive wire 31 of the coil element 5 is covered with an insulating film 33 in the exemplary aspect. It is noted that, at joint portions of the coil element 5 with the solder 23, the insulating film 33 is removed so that the conductive wire 31 and the solder 23 are joined. The coil element 5 can be configured from only the conductive wire 31 that is not covered with the insulating film 33.

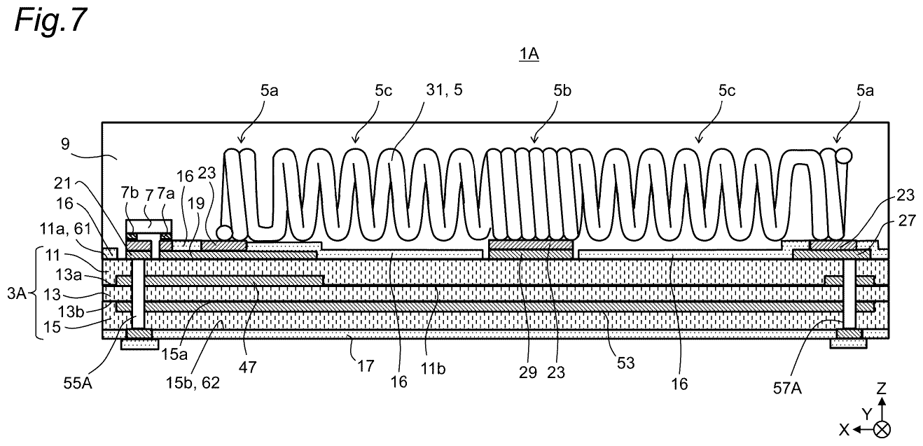

As shown in FIG. 1, the resin layer 9 seals the coil element 5 and the RFIC chip 7, and is laminated on a third main surface 11a of the first base material layer 11 and on the first resist layer 16 as shown in FIG. 7 and described below in another exemplary aspect. The resin layer 9 is formed of, for example, a general sealing resin, such as an epoxy resin in an exemplary aspect.

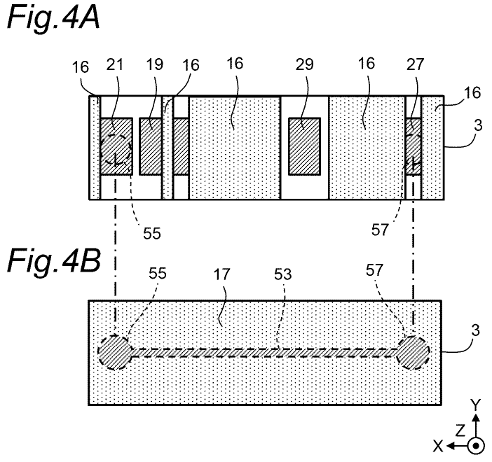

Referring then to FIGS. 4A to 4B, the substrate 3 will be described. FIGS. 4A to 4B are plan views showing wiring electrodes on the substrate 3. FIG. 4A is a plan view showing the wiring electrodes on the first main surface 61 of the substrate 3. FIG. 4B is a see-through plan view seen through the substrate 3, showing wiring electrodes on the second main surface 62. The chain-dotted lines in FIGS. 4A to 4B indicate through-hole connections.

As shown in FIG. 4A, on the first main surface 61 that is the upper surface of the substrate 3, there are arranged the first land 19 connected via the solder 23 to the first terminal 7a of the RFIC chip 7 and the first densely wound portion 5a on the side closer to the RFIC chip 7, and a second land 21 connected via solder 23 to the second terminal 7b of the RFIC chip 7. Also arranged on the first main surface 61 of the substrate 3 are the auxiliary electrode 29 connected via the solder 23 to the second densely wound portion 5b, and the first electrode connected via the solder 23 to the first densely wound portion 5a on the side farther from the RFIC chip 7.

In the exemplary aspect, the first interlayer connection conductor 55 and the second interlayer connection conductor 57 are formed that pass through the inside of the substrate 3. The first interlayer connection conductor 55 is a conductive via that connects the second land 21 and a conductor pattern 53. Similarly, the second interlayer connection conductor 57 is a conductive via that connects the first electrode 27 and the conductor pattern 53.

The first and second interlayer connection conductors 55 and 57 are, for example, conductors formed by solidifying (e.g., metallizing) conductive paste filled in a hole disposed in the insulating substrate 3, but may also be plated through holes. The first and second interlayer connection conductors 55 and 57 are disposed, respectively, facing each other in the respective longitudinal directions of the substrate 3.

The conductor pattern 53 connecting the first interlayer connection conductor 55 and the second interlayer connection conductor 57 is disposed on the second main surface 62 of the substrate 3. The conductor pattern 53 has, for example, a rectilinear shape extending in the longitudinal direction of the substrate 3. Since the conductor pattern 53 is not disposed outside the first and second interlayer connection conductors 55 and 57 in the longitudinal direction, the conductor pattern 53 can be prevented from being scraped off when, for example, the RFID module comes into contact with other articles during the manufacturing process, handling after manufacturing, and the like.

The first land 19, the second land 21, the first electrode 27, the auxiliary electrode 29, and the conductor pattern 53 are each a conductor and are formed by patterning copper foil by photolithography, for example.

An LC parallel resonant circuit is configured within the RFID module 1 and is matched to radio waves of a communication frequency, so that when the coil element 5 receives radio waves of the communication frequency, a current flows through the RFIC chip 7.

As shown in FIGS. 1 and 2, the coil element 5 has the first densely wound portion 5a at both ends and therefore can be soldered to the substrate 3, with the result that the fixing strength of the coil element 5 is increased. As described above, the coil element 5 also has the sparsely wound portion 5c in which the conductive wire 31 is wound more sparsely than the first densely wound portion 5a at locations other than both ends. Since the coupling coefficient Ka of the first densely wound portion 5a and the second densely wound portion 5b is larger than the coupling coefficient Kb of the sparsely wound portion 5c, the magnetic field is more easily emitted from the sparsely wound portion 5c to the outside of the coil element 5 than from the first densely wound portion 5a and the second densely wound portion 5b. In this way, since a large amount of magnetic field is emitted from the sparsely wound portion 5c, the performance of the coil element 5 as an antenna is improved. In addition, in the winding axis direction of the coil element 5, a ratio of the length of the sparsely wound portion 5c is larger than a ratio of the length of the first densely wound portion 5a. In addition, in the winding axis direction of the coil element 5, the ratio of the length of the sparsely wound portion 5c is larger than a ratio of the sum of the length of the first densely wound portion 5a and the length of the second densely wound portion 5b. In this manner, by increasing proportion of the length of the sparsely wound portion 5c, a larger amount of magnetic field is emitted.

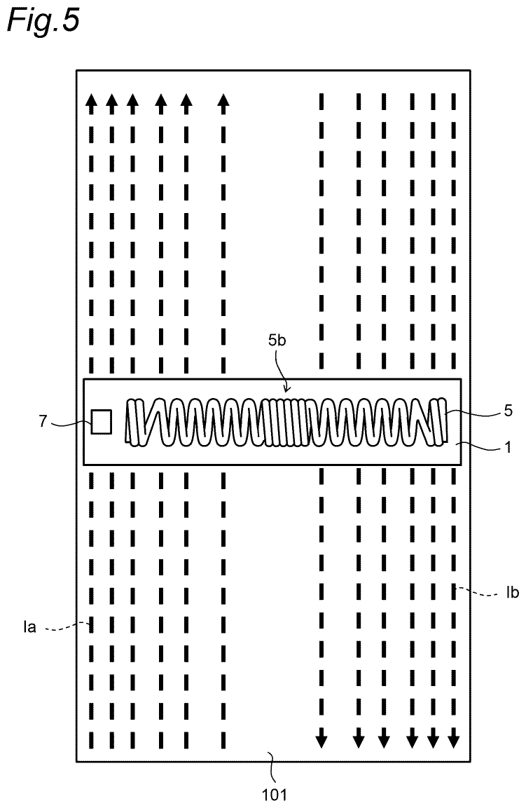

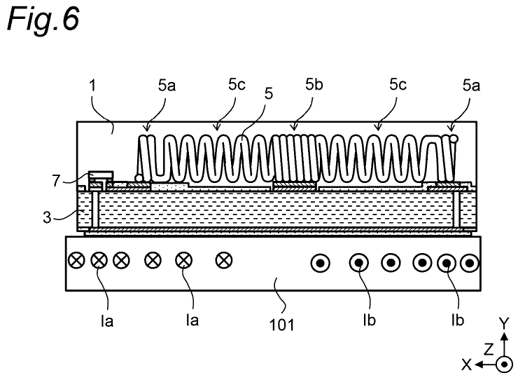

Current flowing through a metal plate 101 when the RFID module 1 is disposed on the metal plate 101 will be described with reference to FIGS. 5 and 6. FIG. 5 is a plan view illustrating currents Ia and Ib flowing through the metal plate 101 when the RFID module 1 is placed on the metal plate 101. FIG. 6 is a longitudinal sectional view illustrating the current flowing through the metal plate 101 when the RFID module 1 is placed on the metal plate 101. It is noted that the substrate 3 is omitted in FIG. 5 to make it easier to understand the current flow.

When the metal plate 101 is used as a radiating element, the coil element 5 of the RFID module 1 couples with a magnetic field generated by current flowing on the metal plate 101. The currents Ia and Ib flowing on the metal plate 101 flow in opposite directions with the center of the coil element 5 of the RFID module 1 as the boundary. Since the current density on the metal plate 101 is higher at the ends of the metal plate 101, the magnetic field at the ends of the metal plate 101 is stronger and the magnetic field at the center of the metal plate 101 is weaker. It is noted that even if the second densely wound portion 5b is present in the center of the coil element 5, it does not significantly affect the magnetic field coupling with the metal plate 101.

As described above, the RFID module 1 of the embodiment includes the substrate 3 having the first main surface 61 and the second main surface 62 facing each other, the RFIC chip 7 disposed on the first main surface 61 side of the substrate 3, and the coil element 5 having the conductive wire 31 wound plural times. The first terminal 7a of the RFIC chip 7 is electrically connected to one end (e.g., a first end) of the coil element 5, and the second terminal 7b of the RFIC chip 7 is electrically connected to the other end (e.g., a second end) of the coil element 5. The coil element 5 has at least one sparsely wound portion 5c, and both ends of the coil element 5 are the first densely wound portions 5a in which the conductive wire 31 is wound at a narrower pitch than in the sparsely wound portion 5c.

According to the RFID module 1 having this configuration, by virtue of employment of the coil element 5 in which the conductive wire 31 is wound plural times (e.g., a plurality of windings), the coil opening diameter can be made larger than when a coil element with legs is used, and hence the size is reduced while maintaining the antenna characteristics. As also described above, the conductive wire 31 is wound at a narrower pitch at both ends of the coil element 5 than at the sparsely wound portion 5c, and the conductive wire 31 is wound at a wider pitch at the sparsely wound portion 5c than at both ends. Thus, the sparsely wound portion is configured to function as an antenna because the magnetic field is easily released to the outside of the coil element 5, and the densely wound ends increase the fixing strength as connection portions for the substrate 3.

The ratio of the length of the sparsely wound portion 5c is greater than the ratio of the length of the first densely wound portion 5a in the winding axis direction of the coil element 5. Since the ratio of the length of the sparsely wound portion 5c is greater than the ratio of the length of the first densely wound portion 5a, the antenna characteristics of the RFID module 1 is improved.

The coil element 5 has the second densely wound portion 5b in which the pitch between the conductor wires 31 is narrower than that of the sparsely wound portion 5c. Due to the coil element 5 having the second densely wound portion 5b, the second densely wound portion 5b is configured to function as a sucked portion to be sucked by a component mounter.

The conductive wire 31 of the coil element 5 may be covered with the insulating film 33. In this case, the inductance component of the coil element 5 can be increased, so that the length of the coil element 5 can be shortened and the RFID module 1 can be made smaller.

It is noted that the conductive wire 31 of the coil element 5 need not be covered with the insulating film 33. In this case, when mounting the coil element 5 on the substrate 3 via soldering, the process of peeling off the insulating film 33 at the joint portions can be omitted.

### Second Exemplary Embodiment

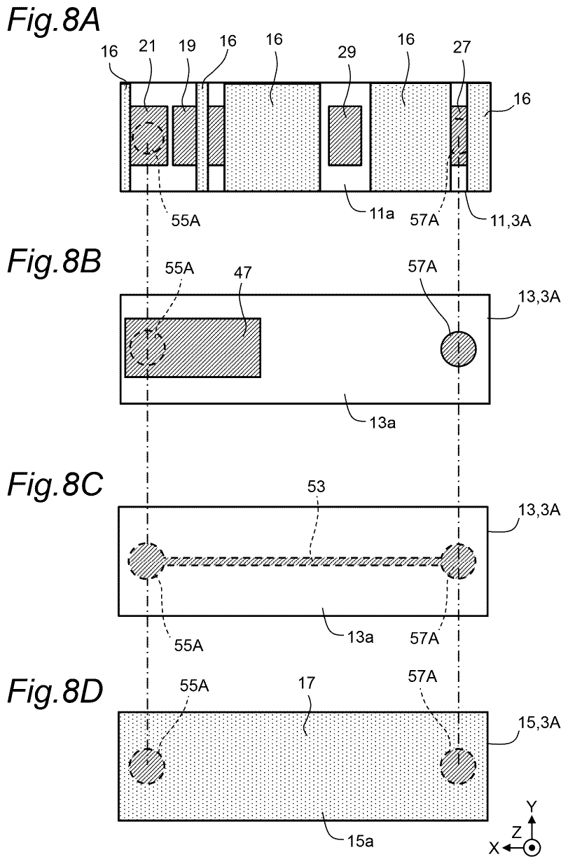

Referring next to FIGS. 7 and 8, an RFID module 1A of a second exemplary embodiment will be described. FIG. 7 is a longitudinal sectional view showing a schema of the RFID module 1A of the second embodiment. FIGS. 8A to 8D are plan views showing each base material layer of a substrate 3A. FIG. 8A is a plan view showing wiring electrodes on the first main surface 61 of the substrate 3A. FIG. 8B is a plan view showing wiring electrodes on a fifth main surface of a second base material layer 13. FIG. 8C is a see-through plan view seen through the second base material layer 13, showing wiring electrodes on a sixth main surface 13b. FIG. 8D is a see-through plan view seen through a third base material layer 15, showing electrodes on an eighth main surface 15b. The chain-dotted lines in FIGS. 8A to 8D indicate through-hole connections.

The substrate 3A in the second embodiment is a laminated substrate, in which the first land 19 extends further toward the center in the longitudinal direction of the substrate 3A than in the first embodiment and includes within the substrate 3A a second electrode 47 that is capacitively coupled to the first land 19. Other than this point and the points described below, the configuration of the RFID module 1A in the second embodiment is the same as that of the RFID module 1 in the first embodiment, and hence description of the common configuration will be omitted.

As shown, the substrate 3A has the first substrate layer 11, the second substrate layer 13, and the third substrate layer 15, with the third substrate layer 15 serving as a bottom substrate, the second substrate layer 13 being laminated on the third substrate layer 15 toward the coil element 5, and the first substrate layer 11 being further laminated on the second substrate layer 13. The first substrate layer 11 to the third substrate layer 15 are each insulating and are, for example, a glass epoxy substrate or a ceramic substrate.

A third main surface 11a of the first base material layer 11 corresponds to the first main surface 61 of the substrate 3. A fourth main surface 11b on the second main surface 62 side of the first base material layer 11 is in contact with a fifth main surface 13a on the first main surface 61 side of the second base material layer 13. The sixth main surface 13b on the second main surface 62 side of the second base material layer 13 is in contact with a seventh main surface 15a on the first main surface 61 side of the third base material layer 15. An eighth main surface 15b, which is the lower surface of the third base material layer 15, faces the seventh main surface 15a and corresponds to the second main surface 62 of the substrate 3.

As shown in FIG. 8B, below the first land 19 and the second land 2, the second electrode 47 is disposed on the fifth main surface 13a that is the upper surface of the second base material layer 13. The second electrode 47 faces the first land 19 and the second land 21, and a capacitance C1 is generated between the first land 19 and the second electrode 47 and between the second land 21 and the second electrode 47.

As shown in FIGS. 7 and 8C, the conductor pattern 53 is disposed on the sixth main surface 13b that is the lower surface of the second base material layer 13. FIG. 8C is a see-through view of the fifth main surface 13a from above.

In the substrate 3A, a first interlayer connection conductor 55A and a second interlayer connection conductor 57A are formed that each extend through the first base material layer 11 and the second base material layer 13. The first interlayer connection conductor 55 is a conductive via that provides connection from the first land 19 through the second electrode 47 to the conductor pattern 53. Similarly, the second interlayer connection conductor 57 is a conductive via that provides connection between the first electrode 27 and the conductor pattern 53.

The first and second interlayer connection conductors 55A and 57A are, for example, conductors formed by solidifying (e.g., metallizing) conductive paste filled in holes disposed in the insulating first base material layer 11 and second base material layer 13, but may also be plated through holes. The first and second interlayer connection conductors 55A and 57A are arranged confronting each other in the longitudinal direction of the first base material layer 11 and the second base material layer 13.

The coil element 5 has an inductance L1, and the conductor pattern 53 has an inductance L2. The capacitance C1 is generated by the first land 19, the second land 21, the first base material layer 11, and the second electrode 47. The RFIC chip 7 has an internal resistance R and capacitance C2. The larger the capacitance C1, the larger the combined capacitance C becomes, and the smaller the resonant frequency f becomes. Moreover, increasing the area of the second electrode 47 can reduce the resonant frequency with the communication frequency.

According to the RFID module 1A of the second embodiment, the substrate 3A has the first base material layer 11 arranged on the first main surface 61 side and the second base material layer 13 arranged on the second main surface 62 side. Moreover, the RFID module 1A includes the first land 19 arranged on the third main surface 11a side of the first base material layer 11 and connected to the first terminal 7a of the RFIC chip 7; the second land 21 arranged on the third main surface 11a side of the first base material layer 11 and connected to the second terminal 7b of the RFIC chip 7; the second electrode 47 facing the first land 19 and the second land 21 and arranged on the fifth main surface 13a side of the second base material layer 13; the first interlayer connection conductor 55A and the second interlayer connection conductor 57A each extending through the first base material layer 11 and the second base material layer 13; and the conductor pattern 53 arranged on the sixth main surface 13b side of the second base material layer 13 and connecting the first interlayer connection conductor 55A and the second interlayer connection conductor 57A. The second land 21, the second electrode 47, and one end (e.g., a first end) of the conductor pattern 53 are connected via the first interlayer connection conductor 55A. The other end (e.g., a second end) of the conductor pattern 53 and the other end (e.g., a second end) of the coil element 5 are connected via the second interlayer connection conductor 57A. The first land 19 and one end (e.g., a first end) of the coil element 5 are connected together.

Since the capacitance C1 is generated by the first land 19, the second land 21, the first base material layer 11, and the second electrode 47, the resonant frequency of the RFID module 1A is reduced.

It is noted that the exemplary embodiment of the present disclosure is not limited as described above and can be modified as follows.

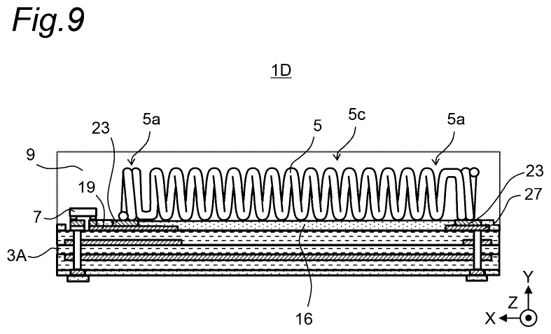

In the above embodiments, the coil element 5 has the second densely wound portion 5b. However, as shown in FIG. 9, a coil element 5D may be employed that does not have the second densely wound portion 5b in another exemplary aspect.

Although the exemplary aspects of the present disclosure have been described with a certain degree of detail in each of the embodiments, the contents of disclosure of these embodiments may vary in details of configuration, and changes in the combination and order of elements in each embodiment may be made without departing from the scope and spirit of the invention as claimed.

### Overview of Embodiments

An RFID module of a first exemplary aspect includes a substrate having a first main surface and a second main surface facing each other; an RFIC chip on the first main surface side of the substrate; and a coil element having a conductive wire wound a plurality of times. A first end of the RFIC chip is electrically connected to a first end of the coil element, while the second end of the RFIC chip is electrically connected to the second end of the coil element. The coil element has at least one sparsely wound portion, with both ends of the coil element being first densely wound portions in which the conductive wire is wound at a narrower pitch than a pitch in the sparsely wound portion.

In the RFID module of this exemplary aspect, by virtue of the coil element in which the conductor wire is wound a plurality of times, the coil opening diameter can be made larger than when a coil element with legs is used. This configuration miniaturizes the RFID module while keeping the antenna characteristics. Both ends of the coil element are first densely wound portions in which the conductor wires are wound at a narrower pitch than in the sparsely wound portion. The sparsely wound section is wound at a wider pitch than in the first densely wound section. Thus, the sparsely wound portion easily releases the magnetic field to the outside of the coil element, functioning as an antenna, and both ends, which are the first densely wound portions, can increase the fixing strength as connecting portions for the substrate.

According to a second exemplary aspect, in the RFID module of the first aspect, the ratio of the length of the sparsely wound portion is greater than a ratio of a length of the first densely wound portions in a winding axis direction of the coil element. Due to the coil element in which the sparsely wound portion is greater in proportion of length than the first densely wound portions, the RFID module has improved antenna characteristics.

According to a third exemplary aspect, in the RFID module of the first aspect, the coil element has a second densely wound portion in which the conductive wire is wound at a narrower pitch than in the sparsely wound portion. This configuration enables the second densely wound portion to function as a sucked portion to be sucked by a component mounter.

According to a fourth exemplary aspect, in the RFID module of the third aspect, the ratio of the length of the sparsely wound portion is greater than the ratio of the sum of the length of the first densely wound portions and the length of the second densely wound portion in the winding axis direction of the coil element. Due to the coil element in which the ratio of the length of the sparsely wound portion is greater than the ratio of the sum of the length of the first densely wound portions and the length of the second densely wound portion, the RFID module has improved antenna characteristics.

According to a fifth exemplary aspect, in the RFID module of any one of the first to fourth aspects, the conductive wire of the coil element is covered with insulating film. This configuration increases the inductance component of the coil element, enabling reduction in length of the coil element and reduction in size of the RFID module.

According to a sixth exemplary aspect, in the RFID module of any one of the first to fourth aspects, the conductive wire of the coil element is not covered with an insulating film. This configuration makes it possible to omit a step of peeling off the insulating film at the joint portions when mounting the coil element on the substrate via solder.

According to a seventh exemplary aspect, the RFID module of the aspect 3 or 4 comprises an auxiliary electrode disposed on the first main surface side of the substrate, wherein the second densely wound portion is connected via solder to the auxiliary electrode. This configuration prevents the coil element from sagging.

According to an eighth exemplary aspect, in the RFID module of any one of the first to seventh aspects, the substrate has a first base material layer disposed on the first main surface side and a second base material layer disposed on the second main surface side. The RFID module comprises a first land disposed on a first main surface side of the first base material layer and connected to a first end of the RFIC chip; a second land disposed on the first main surface side of the first base material layer and connected to the second end of the RFIC chip; a second electrode disposed on a first main surface side of the second main material layer and facing the first land and the second land; first and second interlayer connection conductors each extending through the first base material layer and the second base material layer; and a conductor pattern disposed on a second main surface side of the second main material layer, the conductor pattern connecting the first interlayer connection conductor and the second interlayer connection conductor. The second land, the second electrode, and a first end of the conductor pattern are connected via the first interlayer connection conductor. The second end of the conductor pattern and the second end of the coil element are connected via the second interlayer connection conductor, while the first land and a first end of the coil element are connected together. Since capacitance is generated between the first land and the second electrode and between the second land and the second electrode, the resonant frequency of the RFID module is lowered.

According to a ninth exemplary aspect, in the RFID module of the eighth aspect, the substrate further comprises a third base material layer on which the second main surface side of the second base material layer is laminated. The third base material layer can protect the conductor pattern disposed on the second main surface side of the second base material layer.

### REFERENCE SIGNS LIST

1, 1A RFID module
3, 3A substrate
5 coil element
5a first densely wound portion
5b second densely wound portion
5c sparsely wound portion
7 RFIC chip
7a first terminal
7b second terminal
9 resin layer
11 first base material layer
11a third main surface
11b fourth main surface
13 second base material layer
13a fifth main surface
13b sixth main surface
15 third base material layer
15a seventh main surface
15b eighth main surface
16 first resist layer
17 second resist layer
19 first land
21 second land
23 solder
27 first electrode
29 auxiliary electrode
31 conductive wire
33 insulating film
47 second electrode
53 conductor pattern
55 first interlayer connection conductor
57 second interlayer connection conductor
61 first main surface
62 second main surface
101 metal plate
Ia, Ib current

1. An RFID module comprising:
a substrate having a first main surface and a second main surface;
an RFIC chip on the first main surface of the substrate; and
a coil element having a conductive wire that includes at least one sparsely wound portion,
wherein a first end of the RFIC chip is electrically connected to a first end of the coil element, and a second end of the RFIC chip is electrically connected to a second end of the coil element, and
wherein the first and second ends of the coil element are first densely wound portions in which the conductive wire is wound at a narrower pitch than a pitch of the sparsely wound portion.

2. The RFID module according to claim 1, wherein the first main surface and the second main surface of the substrate face each other.

3. The RFID module according to claim 1, wherein a ratio of a length of the sparsely wound portion is greater than a ratio of a length of the first densely wound portions in a winding axis direction of the coil element.

4. The RFID module according to claim 1, wherein the coil element has a second densely wound portion in which the conductive wire is wound at a narrower pitch than the pitch of the sparsely wound portion.

5. The RFID module according to claim 4, wherein a ratio of a length of the sparsely wound portion is greater than a ratio of a sum of a length of the first densely wound portions and a length of the second densely wound portion in a winding axis direction of the coil element.

6. The RFID module according to claim 1, further comprising an insulating film that covers the conductive wire of the coil element.

7. The RFID module according to claim 1, wherein the conductive wire of the coil element is not covered with an insulating film.

8. The RFID module according to claim 4, further comprising an auxiliary electrode on the first main surface side of the substrate.

9. The RFID module according to claim 8, wherein the second densely wound portion is connected via solder to the auxiliary electrode.

10. The RFID module according to claim 1, wherein the substrate has a first base material layer on a side of the first main surface and a second base material layer on a side of the second main surface.

11. The RFID module according to claim 10, wherein the RFID module comprises:
a first land on a first main surface side of the first base material layer and that is connected to the first end of the RFIC chip;
a second land on the first main surface side of the first base material layer and that is connected to the second end of the RFIC chip;
a second electrode on a first main surface side of the second main material layer and that faces the first land and the second land; and
first and second interlayer connection conductors that each extend through the first base material layer and the second base material layer.

12. The RFID module according to claim 11, wherein the RFID module comprises a conductor pattern on a second main surface side of the second main material layer, the conductor pattern connecting the first interlayer connection conductor to the second interlayer connection conductor.

13. The RFID module according to claim 12, wherein the second land, the second electrode, and a first end of the conductor pattern are connected via the first interlayer connection conductor.

14. The RFID module according to claim 13, wherein a second end of the conductor pattern and the second end of the coil element are connected via the second interlayer connection conductor.

15. The RFID module according to claim 14, wherein the first land is connected to the first end of the coil element.

16. The RFID module according to claim 15, wherein the substrate further comprises a third base material layer on which the second main surface side of the second base material layer is laminated.

17. An RFID module comprising:
a substrate having a first surface and a second surface that oppose each other;
an RFIC chip on the first surface of the substrate and including a first end and a second end; and
a coil element having a conductive wire that includes a sparsely wound portion, the coil element including a first end electrically connected to the first end of the RFIC chip and a second end electrically connected to a second other end of the RFIC chip,
wherein at least one of the first end and the second end of the coil element is a densely wound portion in which the conductive wire has a narrower pitch than a pitch of the sparsely wound portion.

18. The RFID module according to claim 17, wherein both the first end and the second end of the coil element are densely wound portions in which the conductive wire has a narrower pitch than a pitch of the sparsely wound portion.

19. The RFID module according to claim 17, further comprising an auxiliary electrode on the first surface of the substrate and connected to densely wound portion via solder.

20. The RFID module according to claim 17,
wherein the substrate has a first base material layer on a side of the first surface and a second base material layer on a side of the second surface,
wherein the RFID module comprises:
a first land on a first main surface side of the first base material layer and that is connected to the first end of the RFIC chip;
a second land on the first main surface side of the first base material layer and that is connected to the second end of the RFIC chip;
a second electrode on a first main surface side of the second main material layer and that faces the first land and the second land;
first and second interlayer connection conductors that each extend through the first base material layer and the second base material layer;
a conductor pattern on a second main surface side of the second main material layer, the conductor pattern connecting the first interlayer connection conductor to the second interlayer connection conductor,
wherein the second land, the second electrode, and a first end of the conductor pattern are connected via the first interlayer connection conductor,
wherein a second end of the conductor pattern and the second end of the coil element are connected via the second interlayer connection conductor and
wherein the first land is connected to the first end of the coil element.
